(19) United States
(12) Patent Application Publication
(10) Pub. No.: US 2025/0093724 A1
(43) Pub. Date: Mar. 20, 2025

(54) GEL ELECTROLYTE AND ELECTROCHROMIC ELEMENT INCLUDING THE SAME

(71) Applicant: TAI YING OPTRONICS CO., LTD., Taichung City (TW)

(72) Inventors: Yi-Ju SU, Taichung City (TW); Tsung-Hsien LIN, Taichung City (TW); Yu-Nan LEE, Taichung City (TW)

(21) Appl. No.: 18/596,944

(22) Filed: Mar. 6, 2024

(30) Foreign Application Priority Data
Sep. 20, 2023 (TW) 112135817

(51) Int. Cl. G02F 1/1523; C09K 9/00; G02F 1/1514

(52) U.S. Cl. CPC G02F 1/1525; C09K 9/00; G02F 2001/15145

(57) ABSTRACT

A gel-state electrolyte is provided herein. The gel-state electrolyte includes a solvent base; and spherical inorganic nanoparticles dispersed in the solvent base, wherein the spherical inorganic nanoparticles are bonded to each other through an M-O-M structure, wherein M is Ti, Si, Al, Zr, V, Fe, Ni, Zn, or a combination thereof.

### CROSS-REFERENCE TO RELATED APPLICATIONS

This Application claims priority of Taiwan Patent Application No. 112135817, filed on Sep. 20, 2023, the entirety of which is incorporated by reference herein.

### BACKGROUND

### Field of the Invention

The disclosure relates to electrochromic materials, and, in particular, to a gel electrolyte and an electrochromic element including the same.

### Description of the Related Art

Electrochromism is a phenomenon in which the optical properties (reflectivity, transmittance, absorptivity, etc.) of a material undergo a stable and reversible change under the application of an external electric field, which is manifested as a reversible change in the apparent color and transparency.

Currently, most elements including electrochromic materials are sandwich-layered structures, which include glass or plastic substrates, transparent conductive layers (e.g., indium tin oxide), electrochromic layers, electrolyte layers, and ion storage layers. Among these layers, the electrolyte layer used to provide ions to the electrochromic layer can usually be a liquid or a solid electrolyte. Liquid electrolytes are usually more durable and easier to manufacture but may have problems such as difficulty in packaging and leakage of electrolytes. Solid electrolytes, although they do not have the problem of leakage, may have shortcomings such as poor ion conductivity and poor flexibility. Colloidal electrolytes have properties between solid and liquid, which have some of the advantages of liquid electrolytes and some of the advantages of solid electrolytes.

In the past, most methods of manufacturing colloidal electrolytes were employed to make electrochromic molecules into polymer structures or to mix polymer materials into electrochromic materials to form a viscous colloid. Although manufacturing electrochromic elements using this approach has somewhat mitigated the drawbacks of liquid electrochromic elements such as leakage, it often compromises the efficiency of the electrochromic material itself, resulting in increased power consumption or reduced response time.

In summary, it is desirable to provide further improvements to the existing process of manufacturing electrochromic elements to improve the stability of electrochromic elements without reducing efficiency.

### SUMMARY

The present disclosure provides a gel electrolyte, including a solvent base; and a plurality of spherical inorganic nanoparticles dispersed in the solvent base, wherein the plurality of spherical inorganic nanoparticles are bonded to each other through an M-O-M structure, wherein M is Ti, Si, Al, Zr, V, Fe, Ni, Zn, or a combination thereof.

The present disclosure provides an electrochromic element, including: a first substrate with a first conductive layer on a surface of the first substrate; a second substrate with a second conductive layer on a surface of the second substrate, wherein the first conductive layer and the second conductive layer are disposed opposite to each other; a gap filler bonded between the first conductive layer and the second conductive layer to form an accommodating region between the first substrate, the second substrate, and the gap filler; and an electrochromic composition filled into the accommodating region, wherein the electrochromic composition comprises: a gel electrolyte, the gel electrolyte comprises: a solvent base; a plurality of spherical inorganic nanoparticles dispersed in the solvent base, wherein the plurality of spherical inorganic nanoparticles are bonded to each other through an M-O-M structure, wherein M is Ti, Si, Al, Zr, V, Fe, Ni, Zn, or a combination thereof; at least one cathode material; and at least one anode material, wherein at least one of the at least one cathode material and the at least one anode material is electrochromic material.

### BRIEF DESCRIPTION OF DRAWINGS

Aspects of this disclosure are best understood from the following detailed description when read with the accompanying figures. It should be noted that, in accordance with common practice in the industry, various features are not drawn to scale. In fact, the dimensions of the various features may be arbitrarily increased or reduced for clarity of discussion.

FIG. 1 illustrates a preparation process of the gel electrolyte according to some embodiments of the present disclosure.

FIG. 2A illustrates a side view of an electrochromic element including liquid electrolyte according to some embodiments of the present disclosure.

FIG. 2B illustrates a side view of an electrochromic element including gel electrolyte according to some embodiments of the present disclosure.

FIG. 3 shows the transmission spectrum of devices A1 and B1 in neutral and colored states according to some embodiments of the present disclosure.

FIG. 4 shows the transmission spectrum of device A2 in neutral state and in colored state before and after thermal cycles according to some embodiments of the present disclosure.

FIG. 5 shows the transmission spectrum of device B2 in neutral state and in colored state before and after thermal cycles according to some embodiments of the present disclosure.

FIG. 6 shows the transmission spectrum of device A3 in neutral state and in colored state before and after thermal cycles according to some embodiments of the present disclosure.

FIG. 7 shows the transmission spectrum of device B3 in neutral state and in colored state before and after thermal cycles according to some embodiments of the present disclosure.

FIG. 8 shows the transmission spectrum of device A4 in neutral state and in colored state before and after thermal cycles according to some embodiments of the present disclosure.

FIG. 9 shows the transmission spectrum of device A5 in neutral state and in colored state before and after thermal cycles according to some embodiments of the present disclosure.

FIG. 10 shows the transmission spectrum of device A6 in neutral state and in colored state before and after thermal cycles according to some embodiments of the present disclosure.

### DETAILED DESCRIPTION

The following disclosure provides various embodiments, or examples, for implementing different features of the subject matter provided. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features. In addition, the present disclosure may repeat reference numerals and/or letters in the various examples. This repetition is for the purpose of simplicity and clarity and does not in itself dictate a relationship between the various embodiments and/or configurations discussed.

Gel electrolyte is used as an alternative to improve the problems of solution leakage and contamination caused by cracking of liquid electrochromic elements. Most of the existing methods are to make electrochromic molecules into polymer structures or mix polymer materials into electrochromic materials to form a viscous colloid. The gel electrolyte formed by this approach can mitigate the shortcomings of liquid electrochromic elements. However, since most such gel electrolytes transform into a gel state at room temperature spontaneously, such characteristics are often not conducive to the preparation of electrochromic components. Based on the above, the storage stability of existing gel electrolytes is not completely satisfactory.

Therefore, the present disclosure provides a gel electrolyte and an electrochromic device including the same. The gel electrolyte is formed by heating a dispersion including an organic solvent base and inorganic nanoparticles. According to some embodiments of the present disclosure, the gel electrolyte further includes electrochromic materials. According to some embodiments of the present disclosure, the inorganic nanoparticles are spherical with a specific particle size. In this way, by adopting inorganic nanoparticles that are spherical with a specific particle size, the dispersion described in the present disclosure does not transform into a gel state spontaneously when being stored at room temperature (for example, 4° C.-40° C.). Since the gel electrolyte in the present disclosure transforms into a gel state only in specific conditions (i.e. it transforms into a gel state only when being heated). Therefore, compared with the existing methods, the present disclosure provides higher convenience in the preparation and application of elements.

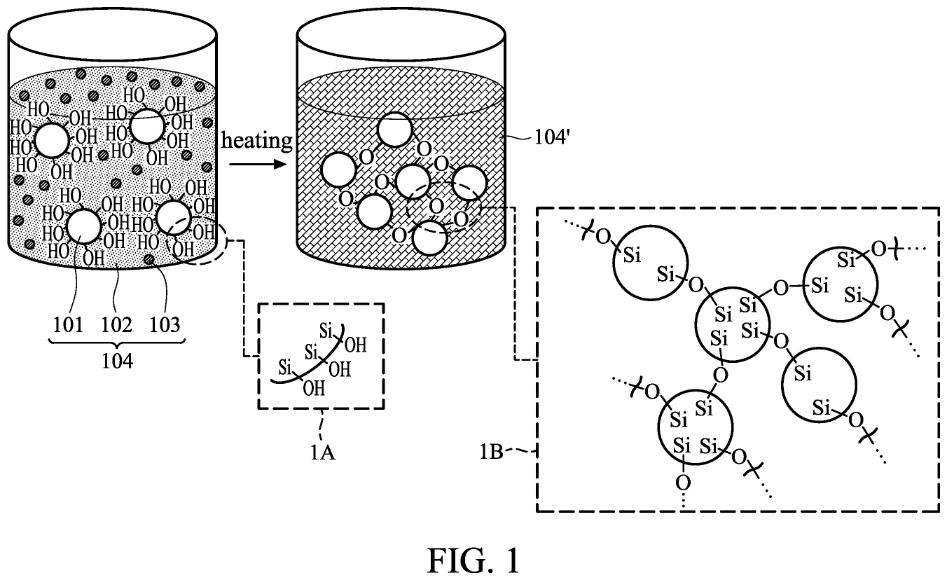

Now, various aspects of the present disclosure will be described in more detail. In this regard, FIG. 1 illustrates a preparation process of the gel electrolyte according to some embodiments of the present disclosure. However, one of ordinary skill in the art will understand that other suitable methods are also applicable.

FIG. 1 illustrates the preparation process of the gel electrolyte according to some embodiments of the present disclosure. First, a plurality of inorganic nanoparticles 101 are dispersed in the solvent base 102, and then the electrochromic material 103 is added. The mixture of the inorganic nanoparticles 101, the solvent base 102, and the electrochromic material 103 is referred to as the dispersion 104. The dispersion 104 is heated to form a gel electrolyte 104′.

According to some embodiments of the present disclosure, the inorganic nanoparticles 101 are materials that can transform into a gel state through heating, such as SiO2, TiO2, Al2O3, ZrO2, V2O5, Fe3O4, NiO, ZnO, or a combination thereof. According to some embodiments of the present disclosure, the inorganic nanoparticles 101 are spherical inorganic nanoparticles with a size ranging from 10 to 40 nm, for example, 10 nm to 30 nm, 15 nm to 30 nm, and 20 nm to 30 nm. According to some embodiments of the present disclosure, the concentration of the inorganic nanoparticles 101 in the dispersion 104 ranges from 5% to 50 wt %, for example, 5% to 40 wt %, 10% to 30 wt %, and 15% to 20 wt %. It should be noted that although the concentration of the inorganic nanoparticles 101 herein may not be limited to the above ranges, in some embodiments, when the concentration of the inorganic nanoparticles 101 in the dispersion 104 is less than a certain extent (for example, <0.5 wt %), the dispersion 104 will not be able to transform into a gel state even being heated.

According to some embodiments of the present disclosure, the solvent base 102 is an organic solvent, which is selected from solvents that can serve as electrolytes. Generally speaking, candidate solvents for solvent substrate 102 are solvents with good electrochemical stability, high dielectric constant, low volatility, and appropriate viscosity. According to some embodiments of the present disclosure, the solvent base 102 may be cyclic carbonates, such as ethylene carbonate (EC), propylene carbonate (PC); chain carbonates, such as diethyl carbonate (DEC), dimethyl carbonate (DMC), ethyl methyl carbonate (EXC), or a combination thereof; other esters such as butyrolactone, valerolactone, or a combination thereof. In some embodiments, the solvent base 102 may be solvents other than esters, such as tetramethylene sulfone, n-methylpyrrolidone, dimethylformamide, dimethylacetamid, and other suitable electrolyte solvents or a combination thereof.

According to some embodiments of the present disclosure, the electrochromic material 103 may transform into a gel-state cathode electrochromic material or an anode electrochromic material. In some embodiments, the cathode material may be C1-C10 alkyl viologen, phenyl viologen, ester viologen, acyl viologen, carboxy anthraquinone, C1-C8 alkyl anthraquinone, ester anthraquinone, acyl anthracene or a combination thereof. In some embodiments, the anode material may be acyl triphenylamine, carbazole triphenylamine, C1-C10 alkylphenazine, phenothiazine, ester phenothiazine, acyl phenothiazine, C1-C8 alkyl phenothiazine, alkoxy phenyl phenothiazine, phenoxazine, ester phenoxazine, acyl phenoxazine, C1-C10 alkyl phenoxazine, p-phenylenediamine, C1-C10 alkyl p-phenylenediamine, ester p-phenylenediamine, acyl p-phenylenediamine, thiophene, C1-C10 alkyl thiophene, ester thiophene, acyl thiophene, nitrile thiophene or a combination thereof. In some embodiments, the concentration of the electrochromic material 103 in the dispersion 104 ranges from 0.005M to 1M, such as 0.02M to 0.8M, 0.03M to 0.6M, 0.04M to 0.4M, and 0.05M to 0.2M.

It should be noted that in some embodiments of the present disclosure, the dispersion 104 remains liquid before being heated even if it is left standing at room temperature for a long time (e.g. >75 hrs, >100 hrs).

According to some embodiments of the present disclosure, the condition for heating the mixture of the dispersion liquid 104 and the electrochromic material 103 is at a temperature of 80° C.-85° C. for 1-2 hours, for example, at a temperature of 100° C.-105° C. for 0.5-1 hour.

According to some embodiments of the present disclosure, the formed gel electrolyte has a solid content ranging from 0.5 to 40 wt %, for example, 0.5 to 35 wt %, and 0.5 to 30 wt %.

According to some embodiments of the present disclosure, the inorganic nanoparticles 101 dispersed in the solution are bonded to each other through an M-O-M structure after being heated. In some embodiments, depending on the inorganic nanoparticle material adopted (for example, the aforementioned exemplary materials such as SiO2, TiO2, Al2O3, or the like), M may be Si, Ti, Al, Zr, V, Fe, Ni, Zn, or a combination thereof. In the embodiment in which the inorganic nanoparticles 101 are SiO2 and the dispersion 104 is acidic, there are Si—OH groups on the surface of the inorganic nanoparticles 101 in an acidic environment, as shown in FIG. 1A, which is a partial enlarged view of the surface of the inorganic nanoparticle 101 in FIG. 1. After heating, the Si—OH groups on the surface of the inorganic nanoparticles 101 are dehydrated to form stable Si—O—Si chemical bonds, so that the inorganic nanoparticles 101 stack with each other to form a network structure, as shown in the partial enlarged view FIG. 1B of the surface of the inorganic nanoparticles 101 in FIG. 1, thereby causing the dispersion 104 to change from a liquid state to a gel electrolyte 104′. In the embodiment in which the solvent base 102 is butyrolactone, butyrolactone can undergo a reversible ring-opening reaction through hydrolysis, and the charges of butyrolactone can subsequently interact with the charges of the inorganic nanoparticles 101 after the ring-opening, thereby contributing to the stacking of the inorganic nanoparticles 101. It should be readily appreciated that although FIG. 1 illustrates SiO2 particles as an example, the present disclosure can use any particles that can undergo dehydration or other condensation reactions to form particles with M-O-M bonds.

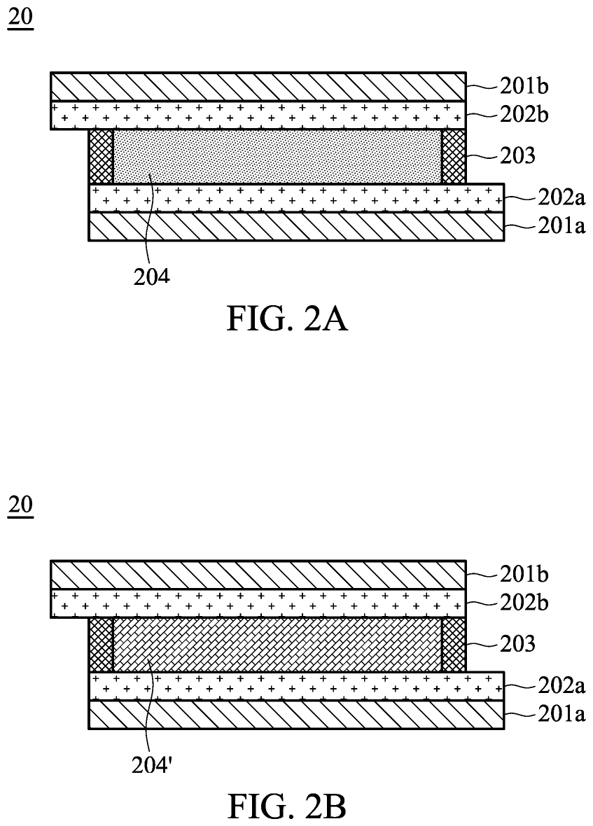

Next, referring to FIG. 2A, in some embodiments of the present disclosure, an electrochromic composition including a gel electrolyte described above is used to manufacture electrochromic elements. According to some embodiments of the present disclosure, a pair of electrodes of the electrochromic element 20 includes a first transparent conductive layer 202a located on the surface of the first transparent substrate 201a, and a second transparent conductive layer 202b located on the surface of the second transparent substrate 201b. The first transparent conductive layer 202a and the second transparent conductive layer 202b are disposed opposite to each other, and the gap filler 203 is bonded between the first transparent conductive layer 202a and the second transparent conductive layer 202b to join the pair of electrodes, thereby forming a closed space between the pair of electrodes and the gap filler 203. Next, a liquid electrochromic composition 204 is injected into the space between the first transparent conductive layer 202a and the second transparent conductive layer 202b and the gap filler 203 through the remaining holes on the gap filler 203 to seal the holes. The liquid electrochromic composition 204 is then transformed into a gel electrochromic composition 204′ by heating, as shown in FIG. 2B, thus completing the manufacturing of electrochromic element 20.

According to some embodiments of the present disclosure, the electrochromic composition 204 includes inorganic nanoparticles 101 and solvent substrate 102 as in the aforementioned exemplary embodiments, as well as one or more cathode materials and one or more anode materials. According to some embodiments of the present disclosure, the cathode materials may be C1-C10 alkyl viologen, phenyl viologen, ester viologen, acyl viologen, carboxy anthraquinone, C1-C8 alkyl anthraquinone, ester anthraquinone, acyl anthracene or a combination thereof. According to some embodiments of the present disclosure, the concentration of the cathode material in the electrochromic composition ranges from 0.001M to 1M, such as 0.02M to 0.5M. In the exemplary embodiments provided herein, the concentration of the cathode material ranges from 0.01M to 1M, such as 0.02M to 0.5M. According to some embodiments of the present disclosure, the anode material may be acyl triphenylamine, carbazole triphenylamine, C1-C10 alkylphenazine, phenothiazine, ester phenothiazine, acyl phenothiazine, C1-C8 alkyl phenothiazine, alkoxy phenyl phenothiazine, phenoxazine, ester phenoxazine, acyl phenoxazine, C1-C10 alkyl phenoxazine, p-phenylenediamine, C1-C10 alkyl p-phenylenediamine, ester p-phenylenediamine, acyl p-phenylenediamine, thiophene, C1-C10 alkyl thiophene, ester thiophene, acyl thiophene, nitrile thiophene or a combination thereof. According to some embodiments of the present disclosure, the concentration of the anode materials in the electrochromic composition ranges from 0.01M to 1M, such as 0.02M to 0.5M.

According to some embodiments of the present disclosure, the first transparent substrate 201a and the second transparent substrate 201b may be made of glass or plastic (such as polycarbonate). The first transparent conductive layer 202a and the second transparent conductive layer 202b include, for example, indium tin oxide (ITO), antimony-or fluorine-doped tin oxide (FTO), antimony-or aluminum-doped zinc oxide, and tin oxide. The gap filler 203 may be made by mixing a gap filler and a thermosetting or photochemically curable adhesive. The adhesives may be, for example, epoxy resin and acrylic resin. The gap filler may be, for example, plastic, glass beads, or some sand powder. The thickness of the gap filler 203 (that is, the distance between the first transparent conductive layer 202a and the second transparent conductive layer 202b) ranges from 1 μm to 300 μm, such as 3 μm to 290 μm, 5 μm to 280 μm, 10 μm to 270 μm, 15 μm to 260 μm, 20 μm to 250 μm, 25 μm to 240 μm, 30 μm to 230 μm, 50 μm to 200 μm, 60 μm to 180 μm, 70 μm to 160 μm, 80 μm to 140 μm, 90 μm to 120 μm, 95 μm to 115 μm, or 100 μm to 110 μm. If the distance between the transparent conductive layers is too small, there might be leakage and uneven discoloration. If the distance between the transparent conductive layers is too large, the response speed becomes slow. When the electrochromic element is not applied with voltage, the original neutral state of the electrochromic composition is transparent. By applying a power such as a positive voltage to the electrochromic element, the color of the electrochromic element will gradually become darkened. Once the power is turned off, the electrochromic composition returns to its original transparent state (neutral state) within a short time (for example, less than 10 seconds). The electrochromic element disclosed in the present disclosure may be used in various fields, such as car windows, rearview mirrors, skylights, large-size smart window applications in buildings, or other suitable fields.

In the present disclosure, spherical inorganic nanoparticles at a certain concentration (for example, 10-30 wt %) are dispersed in a solvent base. When necessary, the M—OH groups on the surface of the inorganic nanoparticles can be dehydrated by heating to a certain temperature (for example, heating to 80° C.-120° C.). The inorganic nanoparticles form a network structure through the M-O-M structure so that the dispersion changes from an original liquid state to a gel state. Since the present disclosure adopts smaller-size spherical inorganic nanoparticles, compared with the larger-sized flaky inorganic nanoparticles used in the existing methods, in the embodiments of the present disclosure, the dispersion of inorganic nanoparticles and solvent base can remain liquid state for a long time at room temperature (for example, 20° C.-40° C.) without spontaneously transforming into a gel state. Therefore, the dispersion provided in the present disclosure transforms into a gel state only when being heated, which improves storage stability and convenience component preparation.

Furthermore, the present disclosure adopts a gel-state substance as the electrolyte of the electrochromic element and mixes appropriate cathode materials and anode materials therein to form an electrochromic composition. With a certain concentration of inorganic nanoparticles, the shielding property of the electrochromic composition and the reliability of operation at high temperatures (for example, 100° C.-120° C.) may be further improved.

In order to make the above and other objects, features, and advantages of the present disclosure more obvious and understandable, several embodiments are enumerated below for a more detailed description together with the accompanying diagrams. However, it should be noted that the conditions used in the examples enumerated below are for illustrative purposes only and are not intended to limit the scope of rights claimed in this disclosure:

### PREPARATION OF GEL ELECTROLYTE

### Example 1

10 g of spherical SiO2 nanoparticles with a size ranging from 15 to 25 nm and 1 mL of electrochromic material, alkylphenazine, were mixed in the reaction flask. Then 90 g of butyrolactone was added to the reaction flask as the solvent to form 80 mL of dispersion, such that the concentration of spherical SiO2 nanoparticles in the dispersion was 10 wt %, and the concentration of the electrochromic material, alkylphenazine, in the dispersion was 0.05 M. The dispersion in the reaction flask was then heated to 80° C. for 600 seconds. During this period, the dispersion slowly changed from a liquid state to a gel state.

### Comparison of Storage Properties of Dispersions

The dispersion of Example 1 before the heating step and Comparative Example 1 were placed at room temperature for testing. The conditions of Comparative Example 1 and Example 1 were the same (type of solvent base, type and concentration of electrochromic material, etc.), except that Comparative Example 1 adopted flaky SiO2 nanoparticles with a size ranging from 20 to 80 nm. The conditions and comparison results of Comparative Example 1 and Example 1 are listed in Table 1 below.

TABLE 1

| | Comparative | |
|---|---|---|
| | Example | Example 1 |
| | (Device B1) | (Device A1) |
| Inorganic nanoparticles | SiO₂ | SiO₂ |
| Inorganic nanoparticle shape | Flaky | Spherical |
| Inorganic nanoparticle size | 20-80 nm | 10-30 nm |
| Inorganic nanoparticle | 10% | 10% |
| concentration (wt %) | | |
| Mix in electrochromic | Alkylphenazine | Alkylphenazine |
| material & concentration | 0.05M | 0.05M |
| Type of solvent used | Butyrolactone | Butyrolactone |
| Forming a gel state at | Yes | No |
| room temperature | | |
| Room temperature | 3 hrs | >100 hrs |
| condensation time | | |
| Transform into a gel state | Yes | Yes |
| (heating to 100° C.) | | |
| Time required to transform | 30 minutes | 2 hours |
| into a gel state | | |

Referring to Table 1, the nanoparticles used in Example 1 were spherical SiO2 nanoparticles with a size ranging from 10 to 30 nm. Therefore, compared to Comparative Example 1, which includes flaky SiO2 nanoparticles with a size ranging from 20 to 80 nm, the unheated dispersion of Example 1 was still in a liquid state even if it was left for a long time (>100 hrs) at room temperature.

### Conditions for Transforming into Gel State

Examples 2-4 and Comparative Examples 2-4 were performed by the steps as in Example 1 with various types and concentrations of electrochromic materials, inorganic nanoparticles, and solvents listed in Table 2. The conditions used in Examples 2-4 (referred to as EX2-EX4 in Table 2) and Comparative Examples 2-4 (referred to as CEX2-CEX4 in Table 2) are listed in Table 2 below.

TABLE 2

| | | | | Transform | |
|---|---|---|---|---|---|
| | | Inorganic | | into a gel state | |
| | | nanoparticles (SiO₂) | Solvent | (heating to | Heating |
| Group | Material | concentration (wt %) | base | 100° C.) | time |
| EX 2 | Alkylphenazine | 30% | Ethylene | Yes | 2 hrs |
| | 0.05M | | carbonate | | |
| EX 3 | Phenothiazine | 30% | Propylene | Yes | 4 hrs |
| | 0.1M | | carbonate | | |
| EX 4 | Diphenyl | 30% | Butyrolactone | Yes | 8 hrs |
| | triphenylamine | | | | |
| | 0.05M | | | | |
| CEX 2 | Tetrabutylammonium | 30% | Butyrolactone | No | >24 hrs |
| | bromide | | | | |
| | 0.1M | | | | |
| CEX 3 | Phenothiazine | <0.5% | Butyrolactone | No | >24 hrs |
| | 0.1M | | | | |
| CEX 4 | Alkylphenazine | 30% | Acetic acid | No | >24 hrs |
| | 0.05M | | | | |

Referring to Example 2 and Comparative Example 2, it can be found that when the concentration of inorganic nanoparticles was large enough (30 wt %), and when alkylphenazine was used as the electrochromic material, the dispersion could transform into a gel state after being heated for several hours (Example 2). On the contrary, as in Comparative Example 2,when the organic salt, tetrabutylammonium bromide, was used as the material, the dispersion still could not transform into a gel state after being heated for a long time (>24 hrs).

Referring to Example 3 and Comparative Example 3, it can be found that when the concentration of inorganic nanoparticles (weight percentage concentration (wt %)) was lower than a certain level (<0.5 wt %) (such as in Comparative Example 3), the dispersion still could not form a gel state after being heated for a long time (>24 hrs).

Referring to Example 4 and Comparative Example 4, it can be found that when acetic acid was used as the solvent instead of a suitable electrolyte solvent (such as in Comparative Example 4), the dispersion still could not form a gel state after being heated for a long time (>24 hrs).

### Solvent Base that can Transform into a Gel State

Table 3 below illustrates Example 5 and Example 6, which can transform into a gel state. According to Example 5 and Example 6 (referred to as EX5 and EX6 in Table 3), dimethylacetamide and acetone may be used as the solvent base to transform into a gel state.

TABLE 3

| | | | | Transform | |
|---|---|---|---|---|---|
| | | Inorganic | | into a gel state | |
| | | nanoparticles (SiO₂) | Solvent | (heating to | Heating |
| | Material | concentration (wt %) | base | 100° C.) | time |
| EX 5 | Alkylphenazine | 30% | Dimethylacetamide | Yes | 4 hrs |
| | 0.05M | | | | |
| EX 6 | Alkylphenazine | 30% | Acetone | Yes | 4 hrs |
| | 0.05M | | | | |

### Inorganic Nanoparticles that can Transform into a Gel State

Table 4 illustrates Example 7 to Example 9, which can transform into a gel state. When the concentration of inorganic nanoparticles was 20 wt %, candidate inorganic nanoparticle types that may be used to transform into a gel state include SiO2, Al2O3, and TiO2.

TABLE 4

| | | | Inorganic | | Transform into | |
|---|---|---|---|---|---|---|
| | | | nanoparticle | | a gel state | |
| | | Inorganic | concentration | | (heating | Heating |
| | Material | nanoparticles | (wt %) | Solvent base | to 100° C.) | time |
| EX 7 | Phenothiazine | SiO₂ | 20% | Butyrolactone | Yes | 4 hrs |
| | 0.1M | | | | | |
| EX 8 | Phenothiazine | A1₂O₃ | 20% | Propylene | Yes | 2 hrs |
| | 0.1M | | | carbonate | | |
| EX 9 | Phenothiazine | TiO₂ | 20% | Ethylene | Yes | 8 hrs |
| | 0.1M | | | carbonate | | |

### Manufacturing of Electrochromic Elements

The following is a detailed description of the manufacture of the electrochromic element according to the embodiment of the present disclosure

### Example 10

7 g of SiO2 spherical inorganic nanoparticles, 2 mL of alkyl viologen solution as anode material, and 3 mL of acyl triphenylamine solution as cathode material were dissolved in butyrolactone to form an electrochromic composition solution. The concentration of SiO2 spherical inorganic nanoparticles in the electrochromic composition solution was 20 wt %, the concentration of the alkyl viologen as anode material in the electrochromic composition solution was 0.05 M, and the concentration of acyl triphenylamine as cathode material in the electrochromic composition solution was 0.05M. Two pieces of ITO conductive glass were cut into suitable sizes, and a gap filler (epoxy resin) was used to separate the glass interval into a 100 μm space to define the spacing between ITO conductive glasses. Then fill the space between the ITO conductive glasses with the electrochromic composition solution previously prepared to seal the space. After sealing, the electrochromic composition solution was heated to 100° C. for 600 seconds. The electrochromic device prepared by this method is referred to as device A1.

### Example 11-15

Table 5 lists the conditions of Examples 11 to 15 (referred to as EX 11 to EX 15 in Table 5). Electrochromic devices according to Examples 11 to 15 were manufactured by a method similar to Example 10, except that Example 11 adopted alkylphenazine and acyl triphenylamine as cathode materials in the electrochromic composition. The concentration of alkylphenazine in the electrochromic composition solution was 0.05M. The concentration of triphenylamine in the electrochromic composition solution was 0.02M; Example 12 adopts phenothiazine as the cathode material in the electrochromic composition. The concentration of phenothiazine in the electrochromic composition solution was 0.05M. The electrochromic devices prepared with the conditions of Examples 11 and 12 was respectively referred to as device A2 and device A3; Example 13 adopts ester anthraquinone as the anode material, adopts tetrathiafulvalene as the cathode material in the electrochromic composition, and adopts ethyl methyl carbonate as the solvent base. The concentration of ester anthraquinone in the electrochromic composition solution was 0.05M. The concentration of tetrathiafulvalene in the electrochromic composition solution was 0.05M; Example 14 adopts ester anthraquinone as the anode material, adopts alkyl phenoxazine as cathode material in electrochromic composition, and adopts tetramethylene sulfone as the solvent base; Example 15 adopts acyl viologen as the anode material in the electrochromic composition, adopts ester p-phenylenediamine as cathode material in electrochromic composition, and adopts ethylene carbonate as the solvent base. The concentration of acyl viologen in the electrochromic composition solution was 0.05M The concentration of ester p-phenylenediamine in the electrochromic composition solution was 0.05M. The electrochromic devices prepared with the conditions of Examples 11 to 15 were respectively referred to as devices A2 to A6.

### Comparative Examples 5-7

Table 5 illustrates the conditions of Comparative Examples 5 to 7 (Referred to as CEX 5 to CEX 7 in Table 5). Electrochromic devices according to Comparative Examples 5 to 7 were manufactured by a method similar to Example 10. The types and concentrations of anode materials, cathode materials, solvent bases, and types of inorganic nanoparticles in Comparative Examples 5, 6, and 7 were the same as those in Examples 10, 11, and 12 respectively. The only difference was that the concentrations of the inorganic nanoparticles in Comparative Examples 5, 6, and 7 in the electrochromic composition were all less than 0.5 wt % (<0.5 wt %). The electrochromic devices prepared with the conditions of Comparative Example 5, Comparative Example 6, and Comparative Example 7 were respectively referred to as device B1, device B2, and device B3.

TABLE 5

| | | | | | | Inorganic |
|---|---|---|---|---|---|---|
| | | Anode | | Cathode | | nanoparticle |
| | Anode | material | | material | | (SiO2) |
| Device | material | conc. | Cathode material | conc. | solvent base | conc. |
| EX 10 | Alkyl | 0.05M | Triphenylamine | 0.05M | Propylene | 20% |
| (Device A1) | viologen | | | | carbonate | |
| CEX 5 | Alkyl | 0.05M | Triphenylamine | 0.05M | Propylene | <0.5% |
| (Device B1) | viologen | | | | carbonate | |
| EX 11 | Alkyl | 0.05M | Alkylphenazines | 0.05M | Butyrolactone | 20% |
| (Device A2) | viologen | | Triphenylamine | 0.02M | | |
| CEX 6 | Alkyl | 0.05M | Alkylphenazines | 0.05M | Butyrolactone | <0.5% |
| (Device B2) | viologen | | Triphenylamine | 0.02M | | |
| EX 12 | Alkyl | 0.05M | Phenothiazine | 0.05M | Butyrolactone | 20% |
| (Device A3) | viologen | | | | | |
| CEX 7 | Alkyl | 0.05M | Phenothiazine | 0.05M | Butyrolactone | <0.5% |
| (Device B3) | viologen | | | | | |
| EX 13 | Esterylanthraquinone | 0.05M | Tetrathiafulvalene | 0.05M | Methyl ethyl | 20% |
| (Device A4) | | | | | carbonate | |
| EX 14 | Alkylanthraquinone | 0.05M | Alkyl phenoxazines | 0.05M | Tetramethylene | 20% |
| (Device A5) | | | | | sulfonate | |
| EX 15 | viologen | 0.05M | Ester | 0.05M | Ethylene | 20% |
| (Device A6) | | | p-phenylenediamine | | carbonate | |

### Transmittance Test

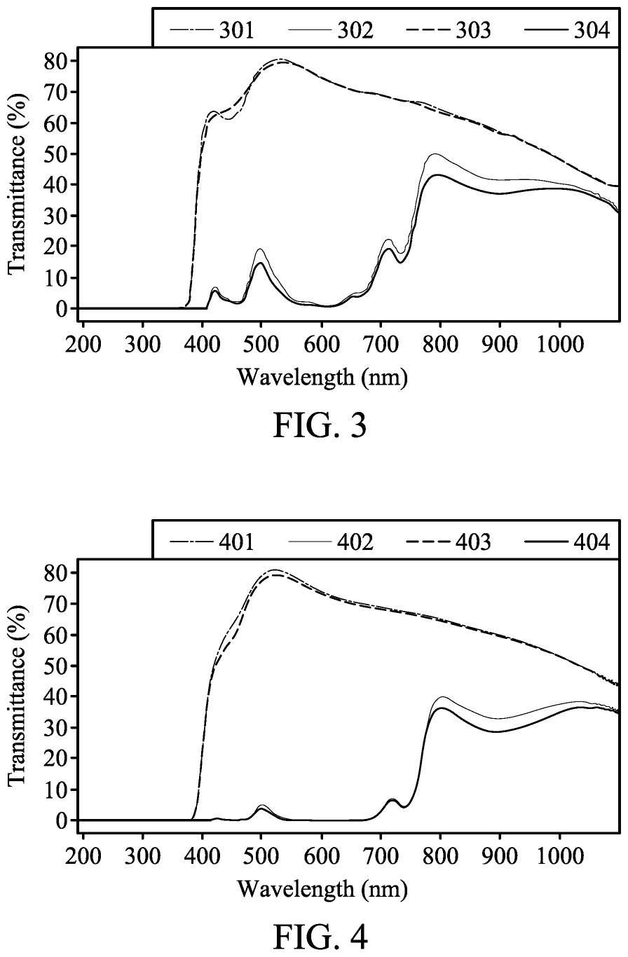

At room temperature, an Agilent 8453 UV-Vis spectrometer was used to detect the UV-Vis spectrum of the electrochromic devices according to the above embodiments and comparative embodiments under the unelectrified (neutral state) condition and under the condition that an operating voltage of 1.2V was applied (colored state). The transmittance spectrum of device A1 and device B1 at wavelengths of 400 nm to 1000 nm are shown in FIG. 3. In FIG. 3, curves 301 and 302 are the transmittance spectrum of device B1 in neutral state and the colored state respectively; curves 303 and 304 are the transmittance spectrum of device A1 in neutral state and the colored state respectively. The transmittance of device A1 and device B1 under the wavelength of 480 nm and 550 nm are shown in Table 6 respectively. When the device is applied with a voltage, the color changes due to the oxidation-reduction reaction between the oxidizable composition and the reducible composition in the electrochromic composition, resulting in a decrease in the transmittance of the device.

TABLE 6

| | | |
|---|---|---|
| Wavelength(nm) | 480 nm | 550 nm |

| | |
|---|---|
| Device | Example 10(A1) |

| | | | |
|---|---|---|---|
| Transmittance (%) | 0 V | 71.25 | 79.68 |
| | 1.2 V | 9.56 | 3.40 |

| | |
|---|---|
| Device | Comparative Example 5(B1) |

| | | | |
|---|---|---|---|
| Transmittance (%) | 0 V | 71.86 | 79.18 |
| | 1.2 V | 7.21 | 2.25 |

As shown in Table 6 above, under the same electrochromic material and concentration, the transmittance was not significantly affected by increasing the concentration of nanoparticles.

### High Temperature Reliability Test

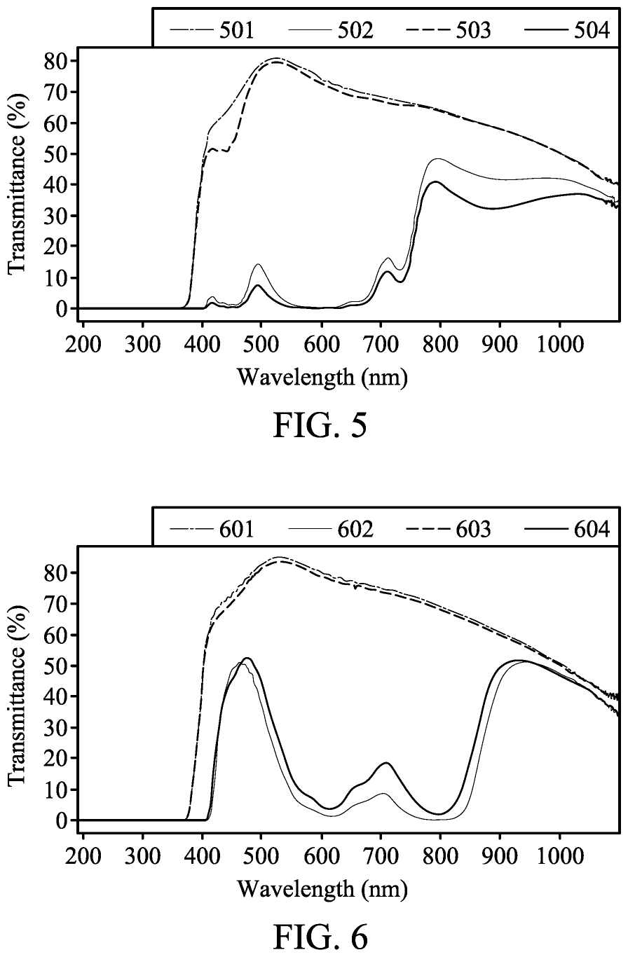

First, a voltage of 1.2V was applied to device A2 and device B2 respectively at room temperature (25° C.), and the transmission spectrum of their colored states were detected. Next, device A2 and device B2 were placed in an environment with a temperature of 85° C., and a voltage of 1.2 V (colored state) was applied to device A2 and device B2 for 20 seconds again, followed by a voltage of 0 V (neutral state) for 40 seconds. The above-mentioned cycle was repeated 5000 times, that is, the high temperature cycle was performed for 5000 minutes. Afterward, device A2 and device B2 were cooled down to room temperature, and a voltage of 1.2 V was applied to device A2 and device B2 again to detect the transmission spectrum of the device in a colored state after the high temperature cycle. The transmission spectrum of neutral state and the colored state of device A2 and device B2 before and after high-temperature cycles are shown in FIG. 4 and FIG. 5 respectively. In FIG. 4, curve 401 and curve 402 are the transmittance spectrum of device A2 in neutral state and colored state at room temperature respectively; curve 403 and curve 404 are the transmittance spectrum of neutral state and colored state of device A2 at high temperature respectively. In FIG. 5, curve 501 and curve 502 are the transmittance spectrum of device B2 in neutral state and colored state at room temperature respectively; curve 503 and curve 504 are the transmittance spectrum of neutral state and colored state of device B2 at high temperature respectively. The decay value of the transmittance of the device at a specific wavelength is defined as the difference between the transmittance of the device after the high-temperature cycle and the transmittance of the device before the high-temperature cycle. That is, transmittance after the high-temperature cycle (%)−transmittance before the high-temperature cycle (%)=decay value (%). The transmittance values of device A2 and device B2 at wavelengths of 480 nm and 550 nm are shown in Table 7 and Table 8 respectively, and their decay values are shown in Table 9.

TABLE 7

| | | |
|---|---|---|
| Wavelength(nm) | 480 nm | 550 nm |

| State | Device A2 |
|---|---|
| | (before high-temperature cycle) |

| | | | |
|---|---|---|---|
| Transmittance (%) | 0 V | 74.65 | 78.83 |
| | 1.2 V | 1.29 | 0.18 |

| State | Device A2 |
|---|---|
| | (after high-temperature cycle) |

| | | | |
|---|---|---|---|
| Transmittance (%) | 0 V | 76.10 | 77.71 |
| | 1.2 V | 1.05 | 0.13 |

TABLE 8

| | | |
|---|---|---|
| Wavelength(nm) | 480 nm | 550 nm |

| State | Device B2 |
|---|---|
| | (before high-temperature cycle) |

| | | | |
|---|---|---|---|
| Transmittance (%) | 0 V | 73.23 | 79.73 |
| | 1.2 V | 6.25 | 1.58 |

| State | Device B2 |
|---|---|
| | (after high-temperature cycle) |

| | | | |
|---|---|---|---|
| Transmittance (%) | 0 V | 68.74 | 78.45 |
| | 1.2 V | 2.83 | 0.56 |

TABLE 9

| | | |
|---|---|---|
| Wavelength(nm) | 480 nm | 550 nm |

| | |
|---|---|
| Device A2 | Decay value |

| | | | |
|---|---|---|---|
| Decay value (%) | 1.2 V | −0.24 | −0.05 |

| | |
|---|---|
| Device B2 | Decay value |

| | | | |
|---|---|---|---|
| Decay value (%) | 1.2 V | −3.42 | −1.02 |

Referring to Table 9 and FIGS. 4 and 5 to compare device A2 and device B2, it may be concluded from Table 9 that because device A2 has a higher concentration of inorganic nanoparticles than device B2, device A2 has lower transmittance values at both the 480 nm wavelength and the 550 nm wavelength. This indicates that the high-temperature reliability of the device may be improved by adding inorganic nanoparticles to the gel electrochromic composition.

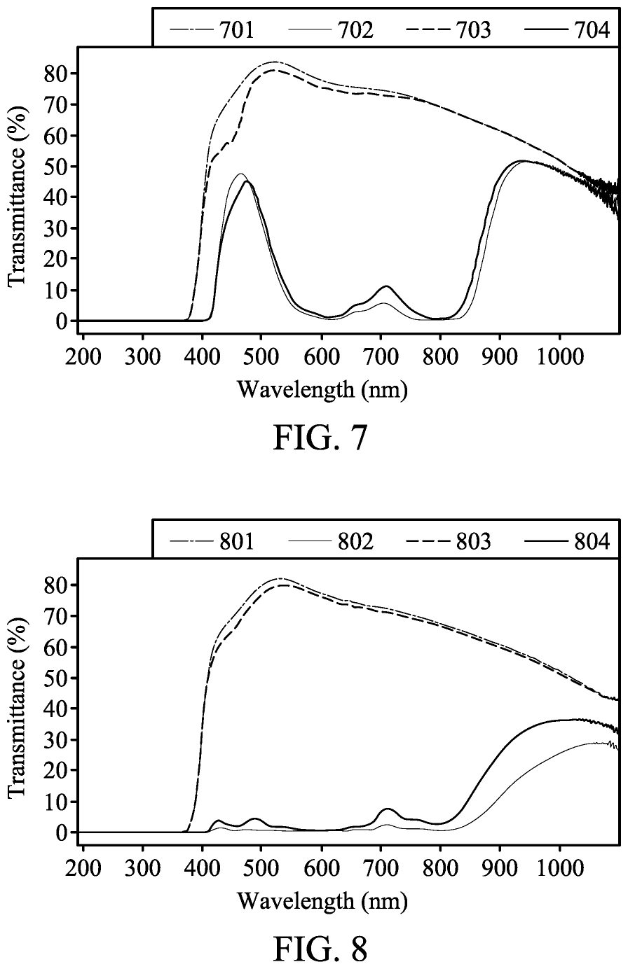

High-temperature reliability tests were conducted on device A3 and device B3 in the same manner as described above. The transmission spectrum of neutral state and colored state of device A3 before and after high-temperature cycles are shown in FIG. 6. The transmission spectrum of neutral state and colored state of device B3 before and after high-temperature cycles are shown in FIG. 7. In FIG. 6, curve 601 and curve 602 are the transmittance spectrum of device A3 in neutral state and colored state at room temperature respectively; curve 603 and curve 604 are the transmittance spectrum of device A3 in neutral state and colored state at high temperature respectively. In FIG. 7, curve 701 and curve 702 are the transmittance spectrum of device B3 in neutral state and colored state at room temperature respectively; curve 703 and curve 704 are the transmittance spectrum of device B3 in neutral state and colored state at a high temperature respectively. The transmittance values of device A3 and device B3 at wavelengths of 480 nm and 550 nm are shown in Table 10 and Table 11 respectively.

TABLE 10

| | | |
|---|---|---|
| Wavelength(nm) | 480 nm | 550 nm |

| | |
|---|---|
| Device A3 | Before high-temperature cycle |

| | | | |
|---|---|---|---|
| Transmittance (%) | 0 V | 79.52 | 84.03 |
| | 1.2 V | 47.43 | 8.33 |

| | |
|---|---|
| Device A3 | After high-temperature cycle |

| | | | |
|---|---|---|---|
| Transmittance (%) | 0 V | 77.78 | 82.68 |
| | 1.2 V | 51.69 | 13.49 |

TABLE 11

| | | |
|---|---|---|
| Wavelength(nm) | 480 nm | 550 nm |

| | |
|---|---|
| Device B3 | Before high-temperature cycle |

| | | | |
|---|---|---|---|
| Transmittance (%) | 0 V | 79.91 | 81.79 |
| | 1.2 V | 42.68 | 4.80 |

| | |
|---|---|
| Device B3 | After high-temperature cycle |

| | | | |
|---|---|---|---|
| Transmittance (%) | 0 V | 75.46 | 79.23 |
| | 1.2 V | 44.09 | 6.36 |

Referring to the transmittance values of device A3 and device B3 before and after high-temperature cycles in Table 10 and Table 11 above, it can be known that when the electrochromic composition has a high concentration (e.g., >20 wt %) of inorganic nanoparticles, its stability in high-temperature operation is better than that of a low concentration (e.g., >0.5 wt %) of inorganic nanoparticles, even in the Examples and Comparative Examples in which the cathode or anode material was replaced with other alternative materials.

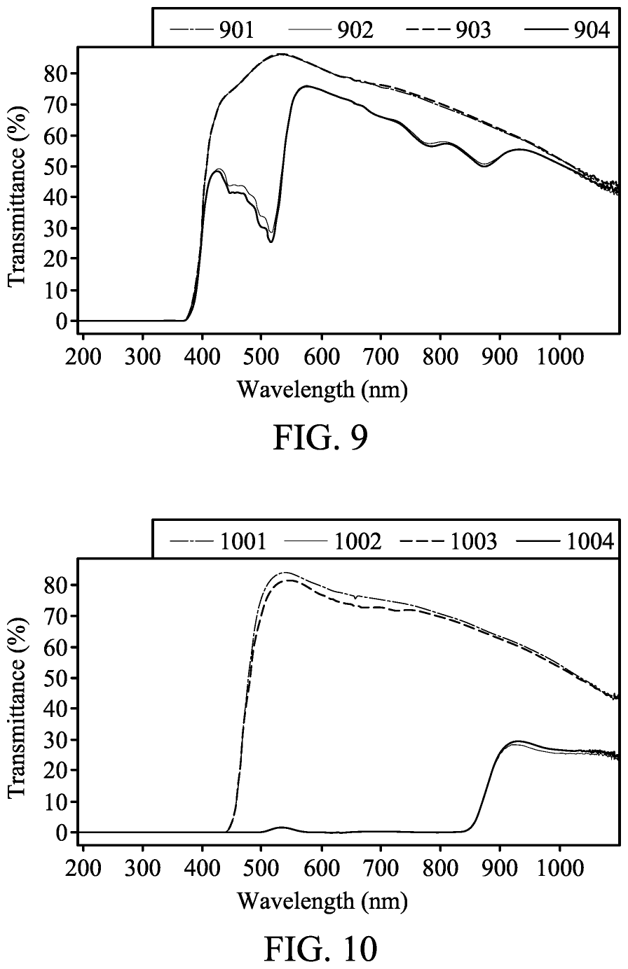

Example 13, Example 14, and Example 15 are provided as examples of other alternative anode materials, cathode materials, and solvent bases. Device A4, device A5, and device A6 corresponding to Example 13, Example 14, and Example 15 were subjected to high-temperature reliability tests in the same manner as described above. The transmission spectrum of neutral state and colored state of device A4 before and after high-temperature cycles are shown in FIG. 8. The transmission spectrum of neutral state and colored state of device A5 before and after high-temperature cycles are shown in FIG. 9. The transmission spectrum of neutral state and colored state of device A6 before and after high-temperature cycles are shown in FIG. 10. In FIG. 8, curve 801 and curve 802 are the transmittance spectrum of device A4 in neutral state and colored state at room temperature respectively; curve 803 and curve 804 are the transmittance spectrum of device A4 in neutral state and colored state at high temperature respectively. In FIG. 9, curve 901 and curve 902 are the transmittance spectrum of device A5 in neutral state and colored state at room temperature respectively; curve 903 and curve 904 are the transmittance spectrum of device A5 in neutral state and colored state at high temperature respectively. In FIG. 10, curve 1001 and curve 1002 are the transmittance spectrum of device A6 in neutral state and colored state at room temperature respectively; curve 1003 and curve 1004 are the transmittance spectrum of device A6 in neutral state and colored state at high temperature respectively. The transmittance values of device A4, device A5, and device A6 at wavelengths of 480 nm and 550 nm are shown in Table 12. Table 13, and Table 14 respectively.

TABLE 12

| Wavelength(nm) | | 480 nm | 550 nm |
|---|---|---|---|
| Device A4 | | Before high high-temperature cycle | |
| Transmittance (%) | 0 V | 76.21 | 81.31 |
| | 1.2 V | 0.49 | 0.03 |
| Device A4 | | After high-temperature cycle | |
| Transmittance (%) | 0 V | 72.98 | 79.79 |
| | 1.2 V | 3.22 | 0.70 |

TABLE 13

| | | |
|---|---|---|
| Wavelength(nm) | 480 nm | 550 nm |

| | |
|---|---|
| Device A5 | Before high-temperature cycle |

| | | | |
|---|---|---|---|
| Transmittance (%) | 0 V | 79.00 | 84.31 |
| | 1.2 V | 40.32 | 68.67 |

| | |
|---|---|
| Device A5 | After high-temperature cycle |

| | | | |
|---|---|---|---|
| Transmittance (%) | 0 V | 78.99 | 84.68 |
| | 1.2 V | 37.57 | 67.43 |

TABLE 14

| | | |
|---|---|---|
| Wavelength(nm) | 480 nm | 550 nm |

| | |
|---|---|
| Device A6 | Before high-temperature cycle |

| | | | |
|---|---|---|---|
| Transmittance (%) | 0 V | 56.24 | 83.63 |
| | 1.2 V | 0.01 | 0.90 |

| | |
|---|---|
| Device A6 | After high-temperature cycle |

| | | | |
|---|---|---|---|
| Transmittance (%) | 0 V | 51.35 | 81.54 |
| | 1.2 V | 0.02 | 0.91 |

Example 13, Example 14, and Example 15 are provided as alternative embodiments using other anode materials, cathode materials, and solvent bases. It may be concluded from the high-temperature reliability test results of the corresponding devices A4, A5, and A6 that in this disclosure, adding inorganic nanoparticles is also suitable for the embodiments adopting other alternative anode materials, cathode materials, and solvent bases. In other words, Example 13, Example 14, and Example 15 illustrate that in the present disclosure, the objects of the present invention can still be achieved in embodiments in which the anode material, the cathode material, and the solvent base are replaced with other materials.

The foregoing outlines features of several embodiments so that those skilled in the art may better understand the aspects of the present disclosure. Those skilled in the art should appreciate that they may readily use present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A gel electrolyte, comprising:
a solvent base; and
a plurality of spherical inorganic nanoparticles dispersed in the solvent base, wherein the plurality of spherical inorganic nanoparticles are bonded to each other through an M-O-M structure, wherein M is Ti, Si, Al, Zr, V, Fe, Ni, Zn, or a combination thereof.

2. The gel electrolyte as claimed in claim 1, further comprising an electrochromic material dispersed in the solvent base.

3. The gel electrolyte as claimed in claim 1, wherein a size of the spherical inorganic nanoparticles ranges from 10 nm to 40 nm.

4. The gel electrolyte as claimed in claim 1, wherein the solvent base comprises ethylene carbonate, propylene carbonate, diethyl carbonate, dimethyl carbonate, ethyl methyl carbonate, butyrolactone, valerolactone, tetramethylene sulfone, n-methylpyrrolidone, dimethylformamide, dimethylacetamide or a combination thereof.

5. The gel electrolyte as claimed in claim 1, wherein a solid content of the gel electrolyte ranges from 0.5 wt % to 40 wt %.

6. An electrochromic element, comprising:
a first substrate with a first conductive layer on a surface of the first substrate;
a second substrate with a second conductive layer on a surface of the second substrate, wherein the first conductive layer and the second conductive layer are disposed opposite to each other;
a gap filler bonded between the first conductive layer and the second conductive layer to form an accommodating region between the first substrate, the second substrate, and the gap filler; and
an electrochromic composition filled into the accommodating region, wherein the electrochromic composition comprises:
a gel electrolyte, wherein the gel electrolyte comprises:
a solvent base;
a plurality of spherical inorganic nanoparticles dispersed in the solvent base, wherein the plurality of spherical inorganic nanoparticles are bonded to each other through an M-O-M structure, wherein M is Ti, Si, Al, Zr, V, Fe, Ni, Zn, or a combination thereof;
at least one cathode material; and
at least one anode material,
wherein at least one of the at least one cathode material and the at least one anode material is electrochromic material.

7. The electrochromic element as claimed in claim 6, wherein a size of the spherical inorganic nanoparticles ranges from 10 nm to 40 nm.

8. The electrochromic element as claimed in claim 6, wherein the solvent base comprises ethylene carbonate, propylene carbonate, diethyl carbonate, dimethyl carbonate, ethyl methyl carbonate, butyrolactone, valerolactone, tetramethylene sulfone, n-methylpyrrolidone, dimethylformamide, dimethylacetamide or a combination thereof.

9. The electrochromic element as claimed in claim 6, wherein the at least one cathode material comprises C1-C10 alkyl viologen, phenyl viologen, ester viologen, acyl viologen, carboxy anthraquinone, C1-C8 alkyl anthraquinone, ester anthraquinone, acyl anthracene or a combination thereof.

10. The electrochromic element as claimed in claim 6, wherein the at least one anode material comprises acyl triphenylamine, carbazole triphenylamine, C1-C10 alkylphenazine, phenothiazine, ester phenothiazine, acyl phenothiazine, C1-C8 alkyl phenothiazine, alkoxy phenyl phenothiazine, phenoxazine, ester phenoxazine, acyl phenoxazine, C1-C10 alkyl phenoxazine, p-phenylenediamine, C1-C10 alkyl p-phenylenediamine, ester p-phenylenediamine, acyl p-phenylenediamine, thiophene, C1-C10 alkyl thiophene, ester thiophene, acyl thiophene, nitrile thiophene or a combination thereof.
